(19) United States
(12) Patent Application Publication
(10) Pub. No.: US 2012/0132206 A1
(43) Pub. Date: May 31, 2012

(54) MULTI-MISSION REBREATHER SYSTEM

(75) Inventor: Mark Alan Johnson, Houston, TX (US)

(73) Assignee: O2 DIVE TECHNOLOGIES, INC., Houston, TX (US)

(21) Appl. No.: 13/306,383

(22) Filed: Nov. 29, 2011

Related U.S. Application Data
(60) Provisional application No. 61/417,656, filed on Nov. 29, 2010.

(51) Int. Cl. A62B 7/10; A62B 7/00

(52) U.S. Cl. 128/204.15

(57) ABSTRACT

An apparatus comprising a scrubber bed; at least one heat sink operatively connected to the scrubber bed; at least one screen connected to the scrubber bed; and a scrubber tube connected to the scrubber bed. Also, a method of using a multiple mission re-breather apparatus, the method comprising attaching the multiple mission re-breather apparatus; using the multiple mission re-breather apparatus in a dry environment; and using the multiple mission re-breather apparatus in a wet environment. Further, a method of controlling a multiple mission re-breather apparatus, the method comprising activating an electronics package of the multiple mission re-breather apparatus, the electronics package comprising software instructions for adjusting operational parameters of the multiple mission re-breather apparatus in response to a change in environmental pressure; and using the multiple mission re-breather apparatus.

### CROSS REFERENCE TO RELATED APPLICATIONS

This application claims the priority of a provisional application under 35 U.S.C. §119(e), namely U.S. patent application Ser. No. 61/417,656 filed on Nov. 29, 2010, which is incorporated by reference in its entirety herein.

### BACKGROUND

1. Field of the Invention

The present invention relates to portable breathing apparatus. More specifically, present invention relates to portable, re-breather breathing apparatus.

2. Background Art

A re breather is a closed loop breathing apparatus that the user exhales into the apparatus where the gas enters a scrubber bed. The scrubber bed chemically absorbs the CO2 from the gas stream but allows the rest of the gas to pass through. Oxygen is added to make up for the oxygen absorbed by the human body. The gas then passes through and is inhaled by the user.

The scrubbing of the CO2 in the scrubber bed creates an exothermic reaction (temperature change). In this case the temperature can increase to 150 degrees F. Because the apparatus is a closed loop, this forces the breathing gas to also increase in temperature. This temperature increase in the gas can cause the user discomfort. Most surface rebreathers use ice blocks to cool the gas for the user.

Accordingly, there exists a need for more efficient re-breather breathing apparatuses that allow for multiple missions.

### SUMMARY OF THE DISCLOSURE

In one aspect, embodiments disclosed herein relate to an apparatus comprising a scrubber bed; at least one heat sink operatively connected to the scrubber bed; at least one screen connected to the scrubber bed; and a scrubber tube connected to the scrubber bed.

In another aspect, embodiments disclosed herein relate to a method of using a multiple mission re-breather apparatus, the method comprising attaching the multiple mission re-breather apparatus; using the multiple mission re-breather apparatus in a dry environment; and using the multiple mission re-breather apparatus in a wet environment.

In another aspect, embodiments disclosed herein relate to a method of controlling a multiple mission re-breather apparatus, the method comprising activating an electronics package of the multiple mission re-breather apparatus, the electronics package comprising software instructions for adjusting operational parameters of the multiple mission re-breather apparatus in response to a change in environmental pressure; and using the multiple mission re-breather apparatus.

Other aspects and advantages of the invention will be apparent from the following description and the appended claims.

### BRIEF DESCRIPTION OF DRAWINGS

FIG. 1 is a side perspective view of a re-breather apparatus according to embodiments of the present disclosure

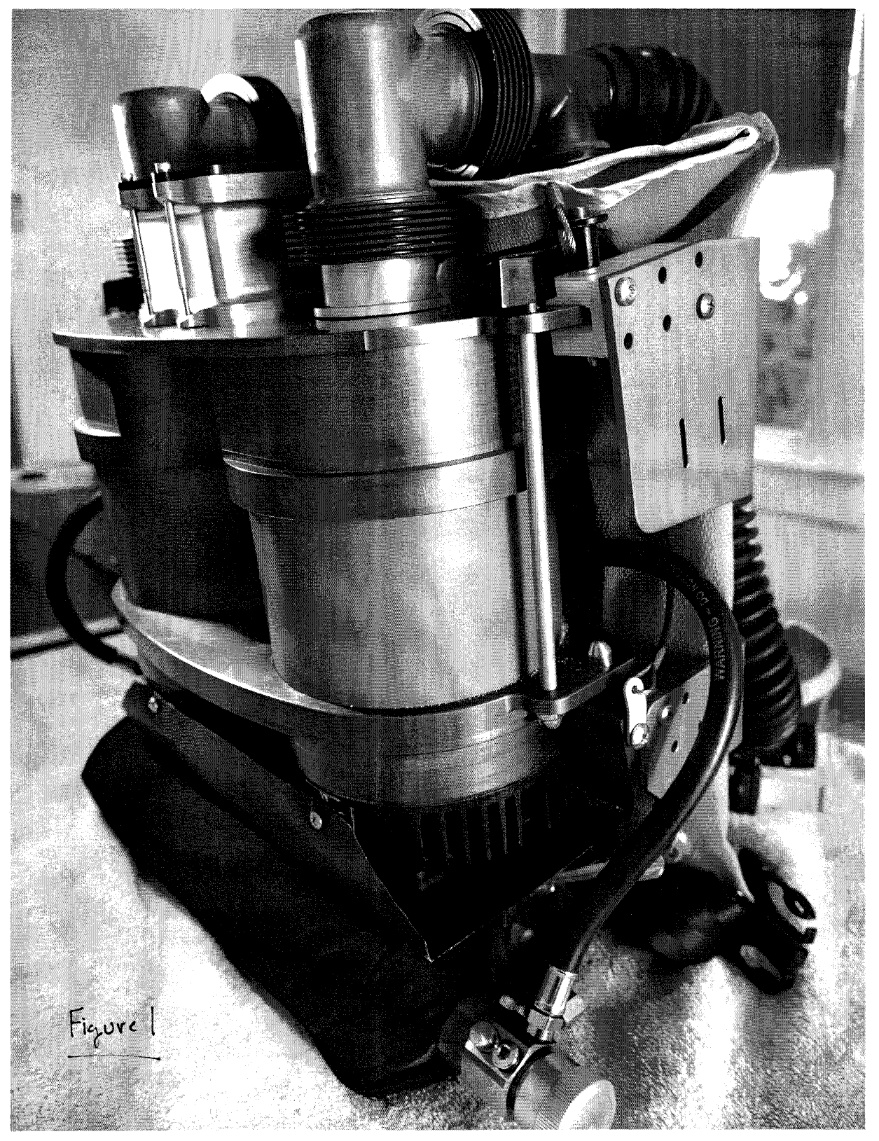

FIG. 2 is a close perspective view of heat sinks according to embodiments of the present disclosure.

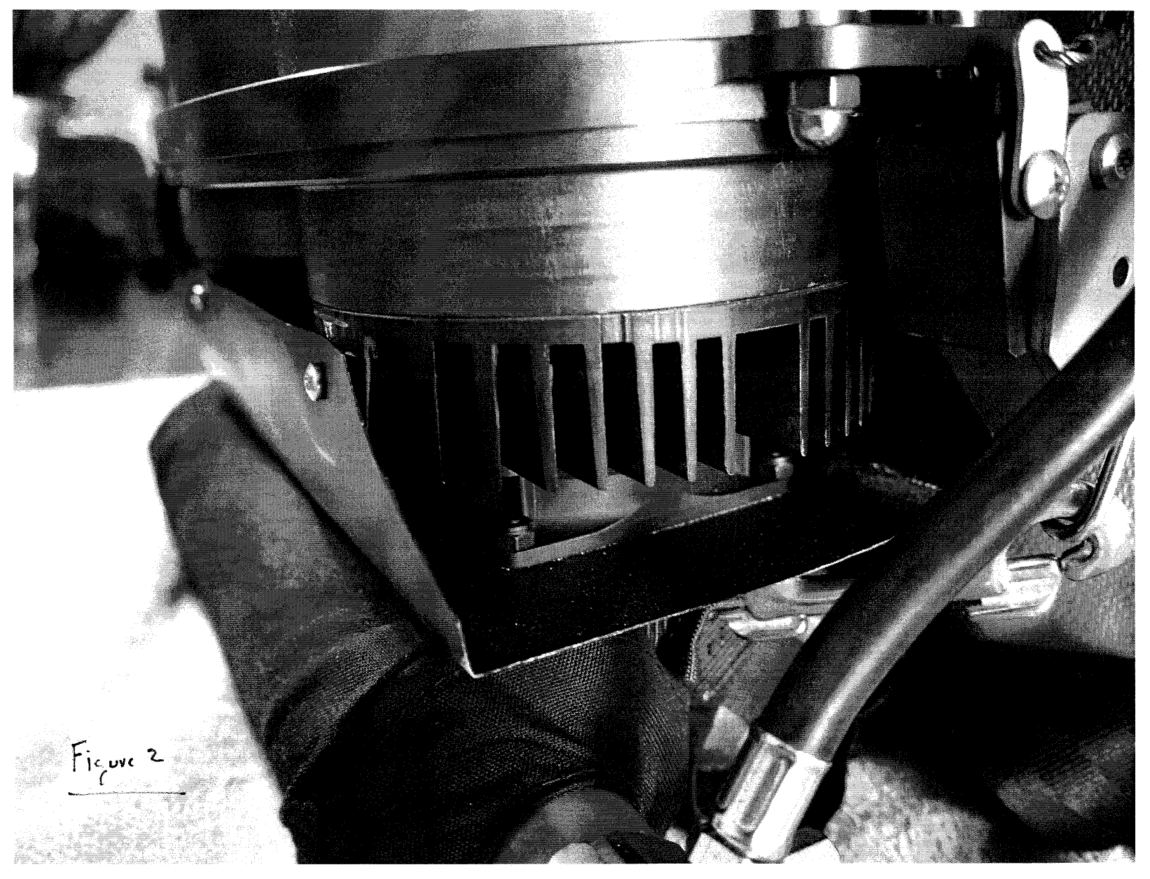

FIG. 3 is a top view of screens according to embodiments of the present disclosure.

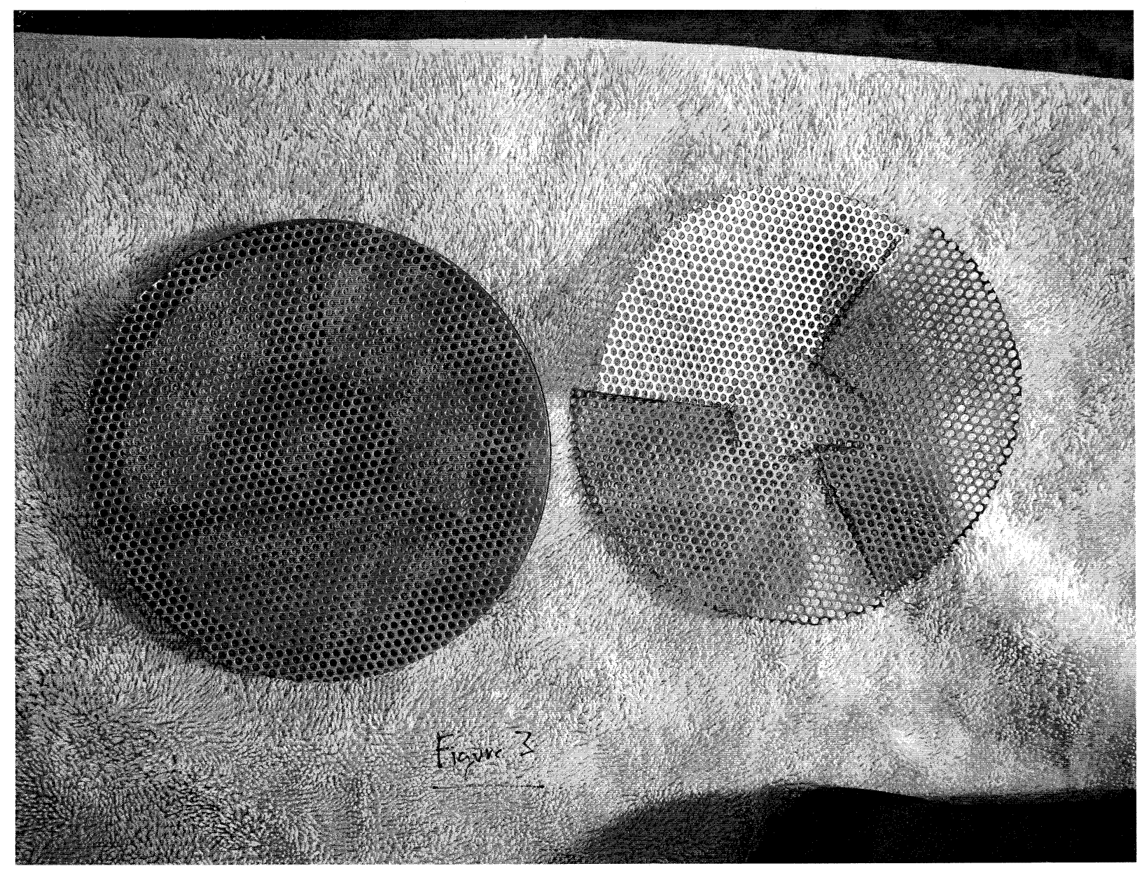

FIG. 4 is a side view of modular scrubbing tubs according to embodiments of the present disclosure.

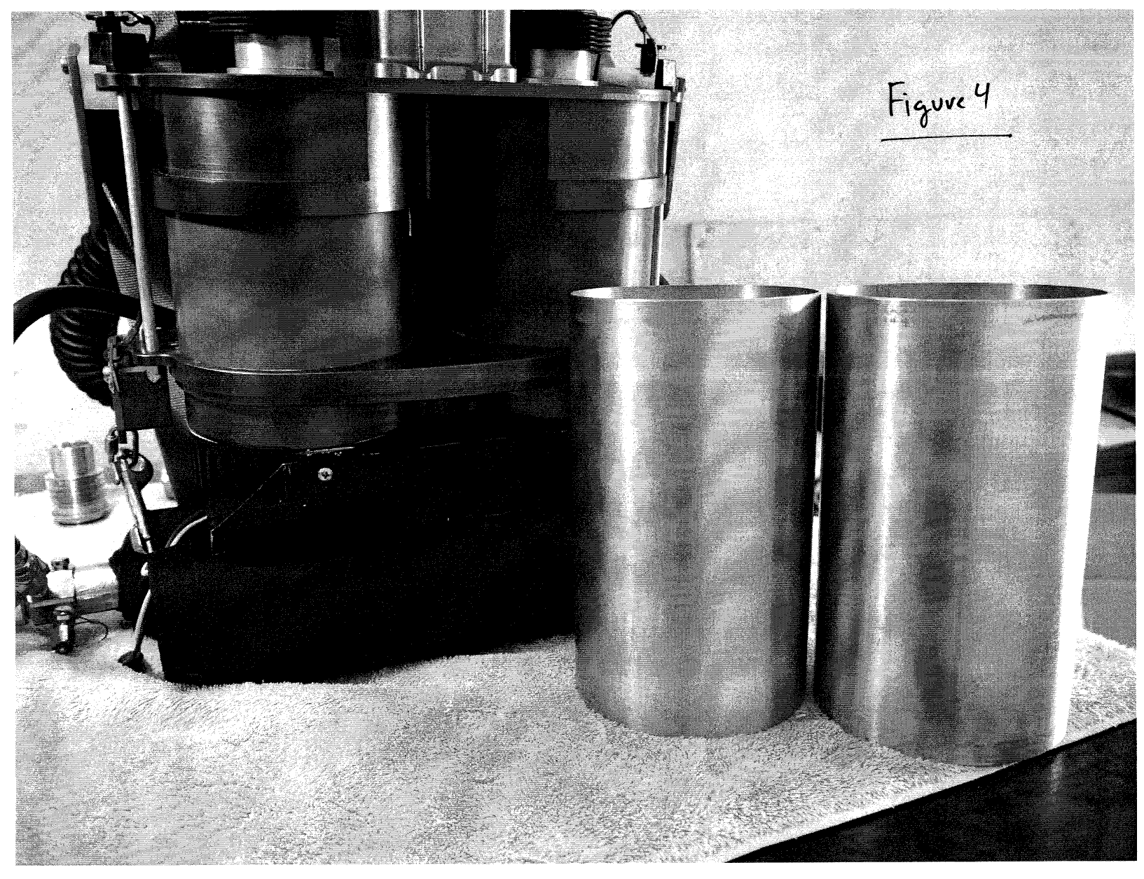

FIG. 5 is a side view of a sealed electronics package according to embodiments of the present disclosure.

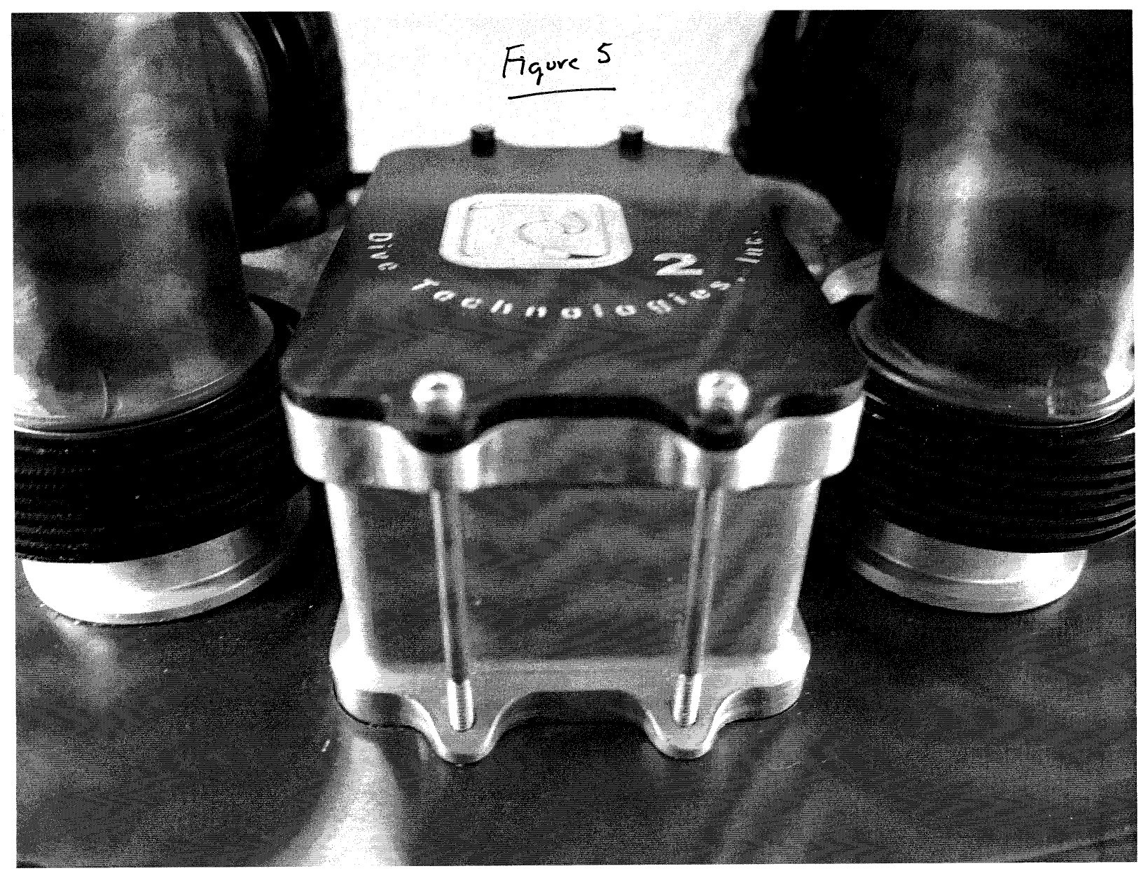

### DETAILED DESCRIPTION

In one aspect, embodiments disclosed herein relate generally to apparatuses and methods for

The Multi Mission ReBreather System (MMRBS) is designed to alleviate high gas temperatures, optimized scrubber bed utilization, and modular to accommodate 2-6 hour duration, able to function in dry and submerged environments and compensates and functions in variable hyperbaric environments.

During operation the system, as the scrubber bed scrubs the CO2 and creates heat, the MMRBS unit is equipped with heat sinks and attached to these heat sinks are electronic Peltier blocks. The blocks create the thermoelectric effect is the direct conversion of temperature differences to electric voltage and vice versa. A thermoelectric device creates a voltage when there is a different temperature on each side. Conversely when a voltage is applied to it, it creates a temperature difference (known as the Peltier effect). At atomic scale (specifically, charge carriers), an applied temperature gradient causes charged carriers in the material, whether they are electrons or electron holes, to diffuse from the hot side to the cold side, similar to a classical gas that expands when heated; hence, the thermally induced current.

The apparatus also uses multiple Stainless Steel Screens inserts in the scrubber bed that optimizes uniform scrubber continuity. They help prevent gas channeling through the rebreather scrubber bed.

The apparatus is designed in a modular fashion to accommodate 2-6 hour duration simply by removing the 2 hour scrubber tubes and replacing them with 4 or 6 scrubber tubes. No other changes need to be replaced.

The apparatus is designed with the electronics and plumbing are sealed in the protected compartment. This allows the unit to be submerged. The electronics are self correcting for changes in environmental pressure.

Proprietary software allows this system to be used in variable hyperbaric environments. Hyperbaric environments are closed pressure vessels such as submarines, chambers or changes in altitude

The Multi Mission ReBreather System (MMRBS) is designed to:

Alleviate high gas temperatures—During operation the system, as the scrubber bed scrubs the CO2 and creates heat, the MMRBS unit is equipped with heat sinks and attached to these heat sinks are electronic Peltier blocks. The blocks create the thermoelectric effect is the direct conversion of temperature differences to electric voltage and vice versa. A thermoelectric device creates a voltage when there is a different temperature on each side. Conversely when a voltage is applied to it, it creates a temperature difference (known as the Peltier effect). At atomic scale (specifically, charge carriers), an applied temperature gradient causes charged carriers in the material, whether they are electrons or electron holes, to diffuse from the hot side to the cold side, similar to a classical gas that expands when heated; hence, the thermally induced current.

Optimized scrubber bed utilization—The apparatus also uses multiple Stainless Steel Screens inserts in the scrubber bed that optimizes uniform scrubber continuity. They help prevent gas channeling through the rebreather scrubber bed.

Modular to accommodate 2-6 hour duration—The apparatus is designed in a modular fashion to accommodate 2-6 hour duration simply by removing the 2 hour scrubber tubes and replacing them with 4 or 6 scrubber tubes. No other changes need to be replaced.

Functions in dry and submerged environments—The apparatus is designed with the electronics and plumbing are sealed in the protected compartment. This allows the unit to be submerged. The electronics are self correcting for changes in environmental pressure.

Compensates and functions in hyperbaric environments—Proprietary software allows this system to be used in variable hyperbaric environments. Hyperbaric environments are closed pressure vessels such as submarines, chambers or changes in altitude.

A Multi Mission ReBreather System (MMRBS) is designed to: alleviate high gas temperatures, optimized scrubber bed utilization, and modular to accommodate 2-6 hour duration, able to function in dry and submerged environments and compensates and functions in variable hyperbaric environments.

Alleviate high gas temperatures—During operation the system, as the scrubber bed scrubs the CO2 and creates heat, the MMRBS unit is equipped with heat sinks and attached to these heat sinks are electronic Peltier blocks. The blocks create the he thermoelectric effect is the direct conversion of temperature differences to electric voltage and vice versa. A thermoelectric device creates a voltage when there is a different temperature on each side. Conversely when a voltage is applied to it, it creates a temperature difference (known as the Peltier effect). At atomic scale (specifically, charge carriers), an applied temperature gradient causes charged carriers in the material, whether they are electrons or electron holes, to diffuse from the hot side to the cold side, similar to a classical gas that expands when heated; hence, the thermally induced current optimized scrubber bed utilization,

The Optimized scrubber bed utilization—The apparatus also uses multiple Stainless Steel Screens inserts in the scrubber bed that optimizes uniform scrubber continuity. They help prevent gas channeling through the rebreather scrubber bed.

Modular to accommodate 2-6 hour duration—The apparatus is designed in a modular fashion to accommodate 2-6 hour duration simply by removing the 2 hour scrubber tubes and replacing them with 4 or 6 scrubber tubes. No other changes need to be replaced.

Functions in dry and submerged environments—The apparatus is designed with the electronics and plumbing are sealed in the protected compartment. This allows the unit to be submerged. The electronics are self correcting for changes in environmental pressure.

Compensates and functions in hyperbaric environments—Proprietary software allows this system to be used in variable hyperbaric environments. Hyperbaric environments are closed pressure vessels such as submarines, chambers or changes in altitude

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. An apparatus comprising:
a scrubber bed;
at least one heat sink operatively connected to the scrubber bed;
at least one screen connected to the scrubber bed; and
a scrubber tube connected to the scrubber bed.

2. The apparatus of claim 1, wherein the at least one heat sink comprises at least one Peltier block.

3. The apparatus of claim 1, wherein the at least one screen comprises stainless steel.

4. The apparatus of claim 1, wherein the at least one screen is configured to channel gas through the scrubber bed.

5. The apparatus of claim 1, wherein the scrubber tubes are modular.

6. The apparatus of claim 5, wherein the scrubber tubes comprise scrubber tubes in the range of 2 to 6 hours.

7. The apparatus of claim 1, further comprising an electronics package.

8. The apparatus of claim 7, wherein the electronics package is sealed in an environmental container.

9. The apparatus of claim 7, wherein the electronics package comprises instructions to correct for changes in environmental pressure.

10. The apparatus of claim 7, wherein the electronics package comprises instructions to allow the system to function in variable hyperbaric environments.

11. A method of using a multiple mission re-breather apparatus, the method comprising:
attaching the multiple mission re-breather apparatus;
using the multiple mission re-breather apparatus in a dry environment; and
using the multiple mission re-breather apparatus in a wet environment.

12. The method of claim 11, wherein the using the multiple mission re-breather apparatus in a wet environment comprises using the multiple mission re-breather apparatus in a submerged environment.

13. A method of controlling a multiple mission re-breather apparatus, the method comprising:
activating an electronics package of the multiple mission re-breather apparatus, the electronics package comprising software instructions for:
adjusting operational parameters of the multiple mission re-breather apparatus in response to a change in environmental pressure; and
using the multiple mission re-breather apparatus.

14. The method of claim 13, wherein the activating comprises controlling at least one Peltier block in at least one heat sink.

15. The method of claim 13, wherein the using comprises using the multiple mission re-breather apparatus in a dry environment.

16. The method of claim 13, wherein the using comprises using the multiple mission re-breather apparatus in a wet environment.

17. The method of claim 16, wherein the using comprises using the multiple mission re-breather apparatus in a wet environment comprises using the multiple mission re-breather apparatus in a submerged environment.

18. The method of claim 13, wherein the software instructions further comprise instructions to adjust an operational parameter of the multiple mission re-breather apparatus in response to a change in temperature.

19. The method of claim 13, wherein the software instructions further comprise instructions to adjust an operational parameter of the multiple mission re-breather apparatus in response to a breathing rate.

20. The method of claim 13, wherein the software instructions further comprise instructions to adjust an operational parameter of the multiple mission re-breather apparatus in response to a scrubbing rate.
